(19) United States
(12) Patent Application Publication
(10) Pub. No.: US 2011/0123740 A1
(43) Pub. Date: May 26, 2011

(54) METHOD FOR MAKING DEVICE HOUSING, AND DEVICE HOUSING

(75) Inventor: CHWAN-HWA CHIANG, Shindian (TW)

(73) Assignee: FIH (HONG KONG) LIMITED, Kowloon (HK)

(21) Appl. No.: 12/852,573

(22) Filed: Aug. 9, 2010

(30) Foreign Application Priority Data
Nov. 20, 2009 (CN) 200910310126.8

(51) Int. Cl. B32B 1/02; B05D 3/04; B32B 27/06

(52) U.S. Cl. 428/35.7; 427/537

(57) ABSTRACT

An exemplary method for making a device housing includes the following steps: providing a substrate made of polyphenylene sulfide resin; plasma treating a surface of the substrate; and forming a non-conductive metallic coat on the treated surface of the substrate. A device housing made by the method includes a substrate and a non-conductive metallic coat formed on the substrate. The substrate is made of polyphenylene sulfide resin. Adhesion between the non-conductive metallic coat and the substrate is more than 3B.

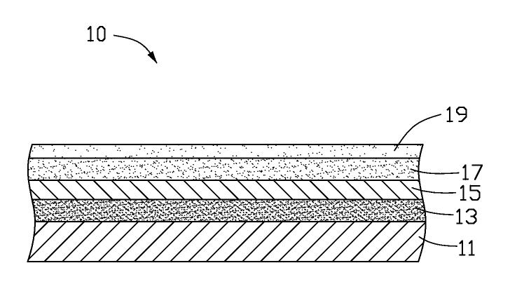

### BACKGROUND

1. Technical Field

The present disclosure relates to methods for making device housings, and to device housings.

2. Description of Related Art

Non-conductive vacuum metallization (NCVM) is now widely used to form non-conductive metallic coats on housings of electronic devices (such as mobile phones, computers, personal digital assistants, and so on) to decorate the electronic devices.

Polyphenylene sulfide (PPS) resin is a crystalline thermoplastic resin with high temperature resistance, high corrosion resistance, and excellent mechanical properties. Additionally, PPS resin is non-toxic. Thus, PPS resin may be an excellent material to manufacture housings of electronic devices. However, the surface energy of PPS resin for device housings is about 34 megajoules per square meter (MJ/m²). This is too low for PPS to get coated with decorative coats such as non-conductive metallic coats.

Therefore, there is room for improvement within the art.

### BRIEF DESCRIPTION OF THE DRAWING

Many aspects of the device housing may be better understood with reference to the following drawing. The components in the drawing are not necessarily drawn to scale, the emphasis instead being placed upon clearly illustrating the principles of the present method and device housing.

The drawing is a schematic, cross-sectional view of an exemplary embodiment of a device housing, showing a part of the device housing.

### DETAILED DESCRIPTION

A method for manufacturing a device housing may include: providing a substrate made of polyphenylene sulfide (PPS) resin; plasma treating a surface of the substrate; and forming a non-conductive metallic coat on the treated surface of the substrate.

Referring to the drawing, in an exemplary embodiment, a device housing 10 may be manufactured by the method as summarized above and more specifically described below.

Specifically, a substrate 11 is provided. The substrate 11 is made of molded PPS resin.

The substrate 11 is plasma treated. Plasma treating the substrate 11 may be carried out in a plasma generator. The plasma generator may be an inductively coupled plasma generator, or a direct-current plasma generator. The source gas for the plasma generator may be oxygen or nitrogen. During the plasma treating process, the plasma generator produces plasma to alter a major surface of the substrate 11 by breaking up the original chemical bonds of the atoms at the surface of the substrate 11. The plasma then combines with the altered atoms of the substrate 11 to form new molecules or one or more masses of material separate from the surface of the substrate 11. As such, the original chemical bonds of the surface of the substrate 11 are altered and the surface energy of the substrate 11 may be increased to, for example, about 50 MJ/m². Additionally, after the plasma treatment process, the surface of the substrate 11 is cleaner and smoother than before.

A base paint coat 13 is coated on the plasma treated surface of the substrate 11. The paint used for the base paint coat 13 may be acrylic acid resin paint or ultraviolet (UV) curing paint. The thickness of the base paint coat 13 may be 1-30 micrometers (μm). The base paint coat 13 can be securely attached on the substrate 11 for enhancing the surface energy of the substrate 11. The adhesion between the base paint coat 13 and the substrate 11 according to the cross-cut test using the American Society for Testing and Materials (ASTM) standard can reach, for example, more than 3 B.

The base paint coat 13 may act as a transition coat to make subsequent coats attach on the substrate 11 more securely.

A non-conductive metallic coat 15 is coated on the base paint coat 13 by non-conductive vacuum metallization. The metal material used for the non-conductive metallic coat 15 may be, for example, selected from a group consisting of indium, tin, titanium, copper, stainless steel, aluminum and aluminum-silicon. The non-conductive metallic coat 15 has a thickness of about 10-100 nanometers (nm). The non-conductive metallic coat 15 is used to decorate the device housing 10 with a metallic appearance.

An intermediate paint coat 17 is coated on the non-conductive metallic coat 15. The intermediate paint coat 17 may be tinted and still transparent, to decorate the device housing 10 with one or more colors. The thickness of the intermediate paint coat 17 may be about 1-20 μm.

A top paint coat 19 is coated on the intermediate paint coat 17. The top paint coat 19 is transparent, and has a thickness of about 10-50 μm. The top paint coat 19 is used for protecting the device housing 10 from abrasion.

It is to be understood that the base paint coat 13 may be omitted, and the non-conductive metallic coat 15 can be directly formed on the substrate 11 with an adhesion of more than 3 B (according to the ASTM standard).

It is to be further understood that the intermediate paint coat 17 and the top paint coat 19 may be omitted when the non-conductive metallic coat 15 itself has a high abrasion resistance.

The device housing 10 according to the exemplary method includes a substrate 11, and a base paint coat 13, a non-conductive metallic coat 15, an intermediate paint coat 17, and a top paint coat 19 formed on the substrate 11 in that order. In this embodiment, the substrate 11 is made of PPS resin and the adhesion of the substrate 11 and the coats 13-19 is more than 3 B (according to the ASTM standard).

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for making a device housing, the method comprising:
providing a substrate made of polyphenylene sulfide resin;
plasma treating a surface of the substrate; and
forming a non-conductive metallic coat on the treated surface of the substrate.

2. The method as claimed in claim 1, wherein plasma treating the surface of the substrate is carried out in a plasma generator.

3. The method as claimed in claim 2, wherein the plasma generator is one of an inductively coupled plasma generator and a direct-current plasma generator.

4. The method as claimed in claim 2, wherein the plasma generator uses one of oxygen and nitrogen as a source gas.

5. The method as claimed in claim 1, wherein the non-conductive metallic coat is formed by a non-conductive vacuum metallization method.

6. The method as claimed in claim 5, wherein forming the non-conductive metallic coat uses material selected from the group consisting of indium, tin, titanium, copper, stainless steel, aluminum and aluminum-silicon.

7. The method as claimed in claim 6, wherein the non-conductive metallic coat has a thickness in the range of from about 10 nanometers to about 100 nanometers.

8. The method as claimed in claim 1, further comprising coating a base paint coat on the treated surface of the substrate before forming the non-conductive metallic coat.

9. The method as claimed in claim 1, further comprising coating an intermediate paint coat on the non-conductive metallic coat.

10. The method as claimed in claim 9, further comprising coating a top paint coat on the intermediate paint coat.

11. A device housing, comprising:
a substrate made of polyphenylene sulfide resin; and
a non-conductive metallic coat formed on the substrate;
wherein adhesion between the non-conductive metallic coat and the substrate is more than 3 B.

12. The device housing as claimed in claim 11, wherein the non-conductive metallic coat is a non-conductive vacuum metalized coat comprising material selected from the group consisting of indium, tin, titanium, copper, stainless steel, aluminum and aluminum-silicon.

13. The device housing as claimed in claim 11, further comprising a base paint coat formed between the substrate and the non-conductive metallic coat.

14. The device housing as claimed in claim 13, wherein the base paint coat has a thickness in the range of about from 1 micrometer to about 30 micrometers.

15. The device housing as claimed in claim 11, further comprising an intermediate paint coat formed on the non-conductive metallic coat.

16. The device housing as claimed in claim 15, wherein the intermediate paint coat has a thickness in the range of from about 1 micrometer to about 20 micrometers.

17. The device housing as claimed in claim 15, further comprising a top paint coat formed on the intermediate paint coat.

18. The device housing as claimed in claim 17, wherein the top paint coat has a thickness in the range of from about 10 micrometers to about 50 micrometers.

19. A method for making a device housing, the method comprising:
providing a substrate made of polyphenylene sulfide resin;
plasma treating a major surface of the substrate such that original chemical bonds of the surface of the substrate are altered and the plasma combines with altered atoms of the surface of the substrate to form new molecules; and
forming a non-conductive metallic coat on the treated surface of the substrate.
